(19) United States
(12) Patent Application Publication
(10) Pub. No.: US 2016/0157653 A1
(43) Pub. Date: Jun. 9, 2016

(54) Apparatus and Method for an Unmanned Aircraft Systems Mail Delivery Receptacle

(71) Applicant: Salvatore Manitta, Auburn, NY (US)

(72) Inventor: Salvatore Manitta, Auburn, NY (US)

(21) Appl. No.: 14/961,330

(22) Filed: Dec. 7, 2015

Related U.S. Application Data
(60) Provisional application No. 62/088,590, filed on Dec. 6, 2014.

(51) Int. Cl. A47G 29/122; B64F 1/32

(52) U.S. Cl. CPC A47G 29/1209; B64F 1/32; B64C 2201/128

(57) ABSTRACT

A package box and mailbox, which is a secure receptacle with a pole extending thru the top part of the box by way to except container held mail and parcel packages. Reusable shipping containers filled with merchandise, or mail slide down the pole by gravity and into the receptacle after an Unmanned Aircraft Systems (drone) delivery provider aligns and detaches from the pole. Ownership Identification is integrated into the receptacle. Weather protection is provided by the receptacle and shipping containers. The receptacle and pole can be mounted by a bracket.

### CROSS-REFERENCE TO RELATED APPLICATIONS

Provisional Application No. 62/088,590

### STATEMENT REGARDING FEDERALLY SPONSORED RESEARCH AND DEVELOPMENT

Not applicable.

### REFERENCE TO A SEQUENCE LISTING, A TABLE, OR A COMPUTER PROGRAM LISTING COMPACT DISK

Not applicable

### BACKGROUND OF INVENTION

U.S. Patent classification: 232/21

Commercial applications with Unmanned Aircraft Systems (drones) are becoming more common and beneficial to society. Many countries are delivering packages and mail by drone. There is a need for efficient delivery of UAS packages.

Anti-theft security is a concern.

Mailbox, package box ownership identification is a concern.

Package delivery confirmation is a concern.

Package cleanliness is a concern.

Cost is concern.

Package dryness is a concern.

Safety is a concern.

### BRIEF SUMMARY OF THE INVENTION

The present invention overcomes the difficulties and concerns described above by integrating structure, UAS (drone) visual landing identification, magnetic properties, lighting, product ownership identification and safety labeling. The apparatus is designed to except UAS (drone) mail and packages from various shipping companies. The re-usable shipping containers can be returned to the service provider for reuse. The apparatus is designed for outdoor use at home, or business. The Apparatus can be mounted to a post, or side wall bracket. The apparatus is designed to provide a stable pole alignment platform for the shipping providers UAS operations. Electronics and battery compartments are located in the base of the receptacle. The lights can be activated by an internal or remote switch. The apparatus can function without power. The flashing lights inside the top of the pole head are 12 volt DC powered. Primarily designed only to receive mail and packages for UAS (drone) safety concerns, it can be used for returns by means of a bracket structure extending from the base of the pole. Package confirmation can be obtained by UAS shipping provider taking a picture of package dropping down apparatus pole. Front mailbox compartment access by means of a lockable access door. The reusable shipping containers fit around the apparatus pole and are hinged for easy removal. The apparatus provides protection from weather. The re-usable shipping containers are waterproof. Safety concerns are addressed, per the pole height positioned well above people and pets.

BRIEF DESCRIPTION OF THE SEVERAL VIEWS OF THE DRAWINGS

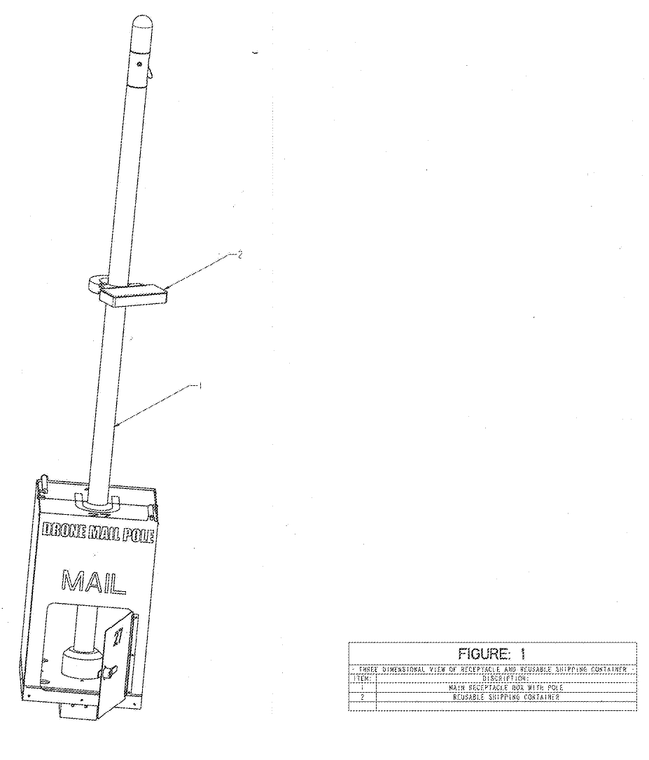

FIG. 1. Three dimensional view of receptacle and re-usable shipping container.

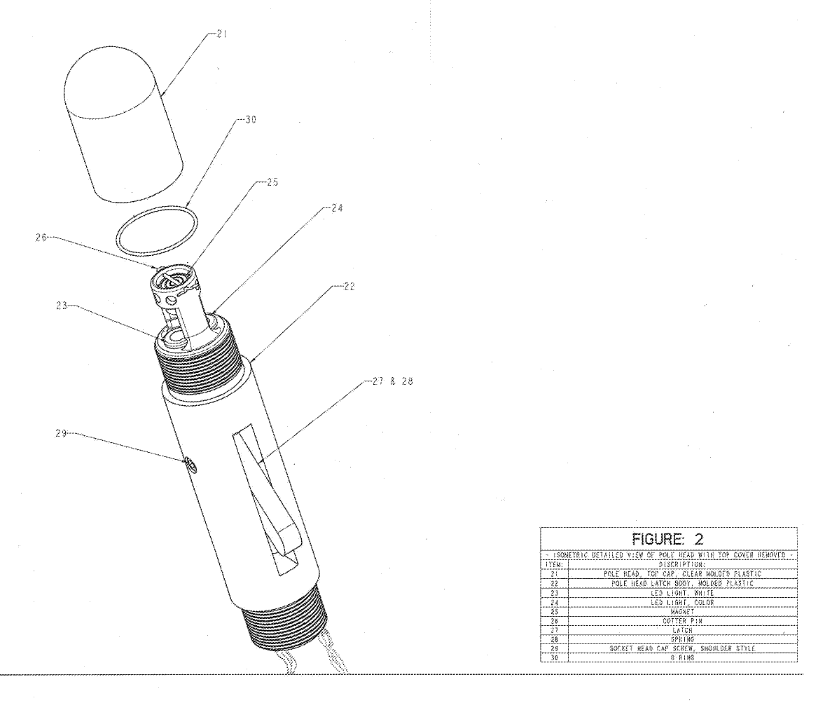

FIG. 2. Isometric detailed view of pole head with top cover removed.

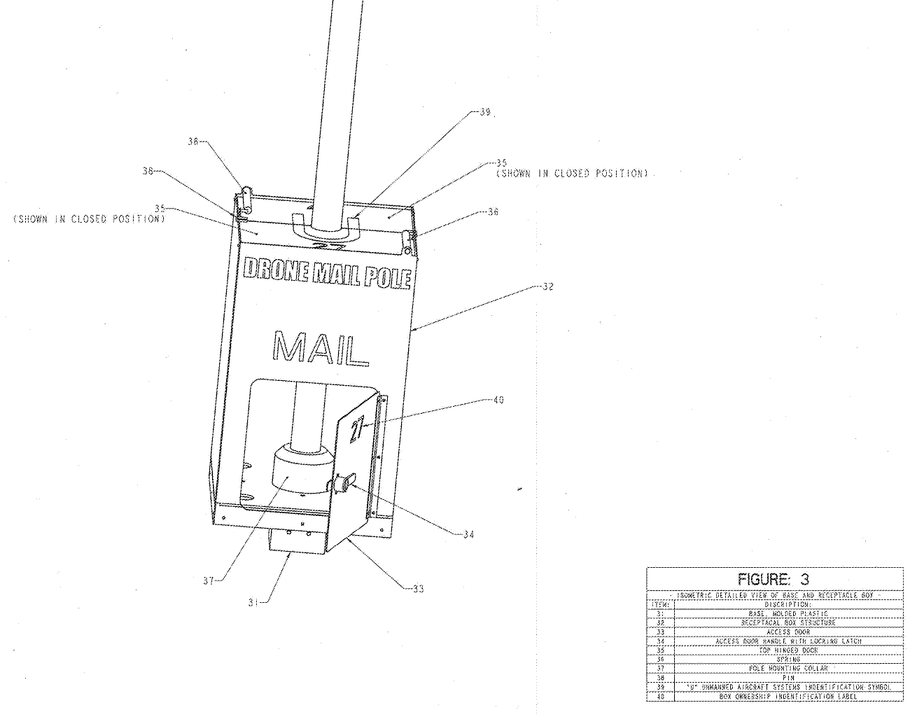

FIG. 3. Isometric detailed view of base and receptacle box

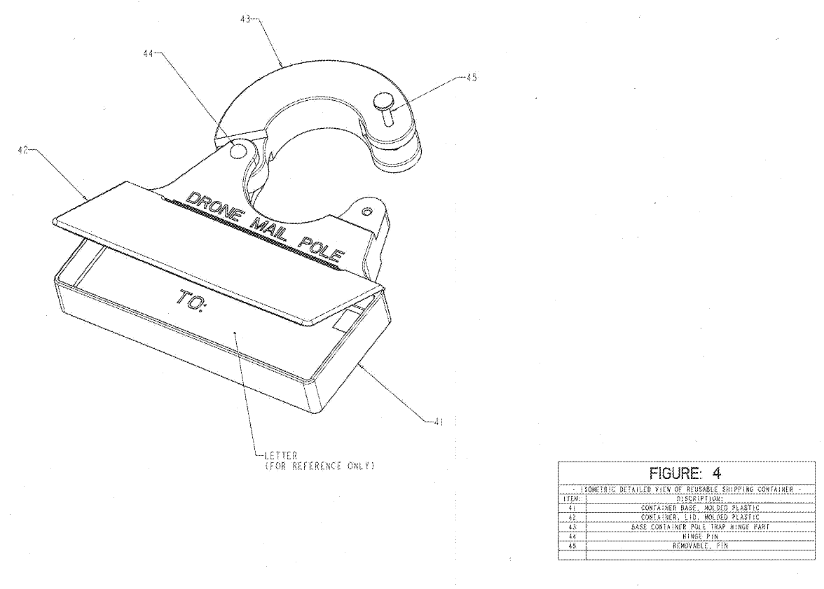

FIG. 4. Isometric detailed view of re-usable shipping container.

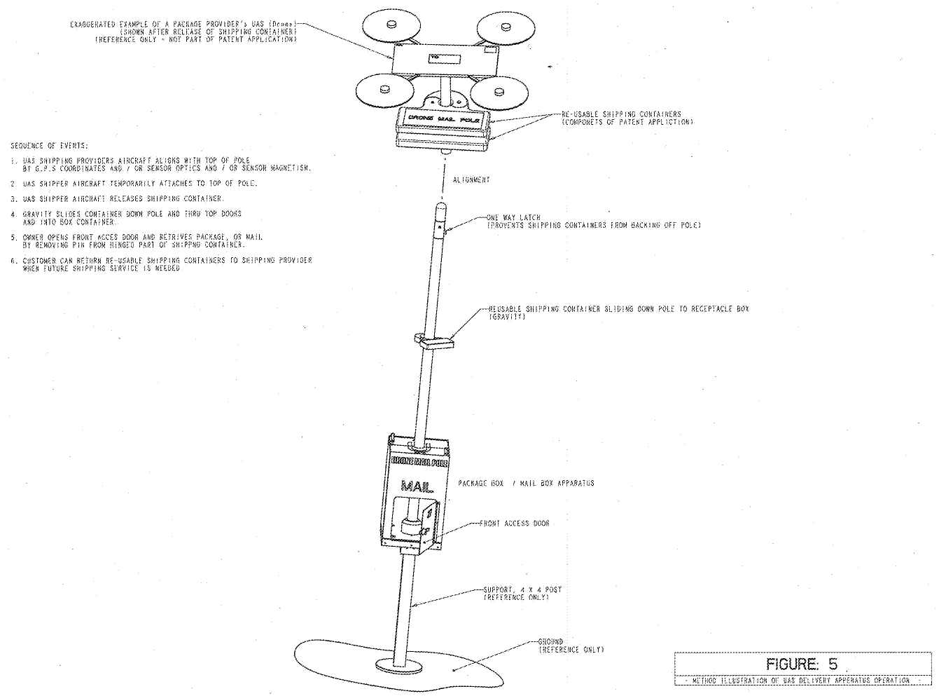

FIG. 5. Method illustration of UAS delivery apparatus operation.

### DETAILED DESCRIPTION OF THE INVENTION

The main compartment of the apparatus consists of a square modeled plastic base, four walls and two spring loaded hinged doors on the top. FIG. 3

The base has a flange for mounting a bracket to a ground post, or wall to support the apparatus upright.

A plastic pole protrudes perpendicular from the base of the compartment, thru the top of the compartment to a given length. FIG. 1

A plastic one way latch mechanism is located at the top of the pole so that a re-usable shipping container will not back off the pole after delivery. FIG. 2

There are water drainage holes located in the base.

At the top of the pole is a clear plastic cap which protects magnet and two led flashing lights.

Owners access the main compartment thru a lockable front door.

Delivered containers rest at the on top of the base and simply need to be removed off the pole by means of pulling a removable pin from the hinge of the container. FIG. 4

A capital “U” letter is used as a symbol for UAS (drone) visual identification. “U” stands for Unmanned Aircraft Systems. Red reflective tape.

FIG. 5, illustrates how the apparatus functions. GPS coordinates for location; magnetism, flashing led lights and “U” identification symbol help locate apparatus and align UAS delivery aircraft into position on top of pole.

There is safety labeling on the outside and inside of main compartment box.

There is apparatus ownership identification on the outside side surfaces of the main compartment box.

1. The apparatus and method is a secure receptacle with a pole extending thru the top by way to except container held mail and parcel packages, sliding down the pole by gravity and into the receptacle after an Unmanned Aircraft Systems (drone) delivery provider aligns and detaches from the pole.

2. A feature of the apparatus of claim 1 is a magnet enclosed inside of the top cap of the pole.

3. A feature of the apparatus of claim 1 are two flashing, colored led lights inside of the top cap of the pole.

4. A feature of the apparatus of claim 1 is a one way latch mechanism near the top of the pole.

5. Features of the apparatus of claim 1 are hinged doors at the top of the receptacle.

6. A feature of the apparatus of claim 1 is a lockable access door at the front of the receptacle.

7. A feature of the apparatus of claim 1 is a receptacle base designed to except a mounting bracket.

8. A feature of the apparatus of claim 1 is a visual identification letter: “U” (Unmanned Aircraft Systems) on the top surface of the receptacle.

9. A feature of the apparatus of claim 1 is an electronics compartment in the base of the receptacle.

10. A feature of the apparatus of claim 1 is a remote control switch.

11. A feature of the apparatus of claim 1 is identification lettering and numbering.

12. A feature of the apparatus of claim 1 is water drainage holes in the base of the receptacle.

13. A feature of the apparatus of claim 1 is a reusable, hinge removable waterproof shipping container with a hole sized to the circumference of the pole.
